(19) United States
(12) Patent Application Publication
(10) Pub. No.: US 2021/0352948 A1
(43) Pub. Date: Nov. 18, 2021

(54) Composition for treating diabetes based on traditional Chinese medicine nutritional therapy and application thereof

(71) Applicant: Dongbo Liu, Changsha (CN)

(72) Inventors: Dongbo Liu, Changsha (CN); Ruiyu Wu, Changsha (CN); Jian Li, Changsha (CN); Xihu Lai, Changsha (CN)

(73) Assignee: Dongbo Liu

(21) Appl. No.: 17/387,812

(22) Filed: Jul. 28, 2021

Related U.S. Application Data
(63) Continuation of application No. PCT/CN2019/111908, filed on Oct. 18, 2019.

(30) Foreign Application Priority Data
Jun. 27, 2019 (CN) 201910568238.7

(51) Int. Cl. A23L 33/21; A23L 2/52; A23L 2/38; A23L 2/02; A23L 33/12; A23L 33/17; A23L 33/125

(52) U.S. Cl. CPC A23L 33/21; A23L 2/52; A23L 2/38; A23L 33/125; A23L 33/12; A23L 33/17; A23L 2/02

(57) ABSTRACT

A composition for treating diabetes based on traditional Chinese medicine nutritional therapy, wherein the composition is a low GI composition, and the composition comprises available carbohydrates, fat, protein, and dietary fiber and Chinese medicine extract components; wherein as a dosage of the composition for a day, an amount of dietary fiber presented in the composition is at a range of 10-40 g; a total energy of the composition is at a range of 400-1300 calories, wherein energy provided by the carbohydrates is 15-45% of a total energy of the composition; the energy provided by the fat is 40-80% of a total energy of the composition, and a mass fraction of unsaturated fatty acids takes 50-80 of a total mass of the fat. When applied, the composition provided by the present invention is a food in solid form formed by processing the above-mentioned multiple natural raw materials containing the same raw materials of medicine and food with supplementary materials; the food includes breakfast, dinner 1 and dinner 2 used in combination, with the “three lows and three highs” diet, combined with the intermittent fasting diet, can effectively reduce the blood sugar levels of diabetic patients.

### CROSS REFERENCE OF RELATED APPLICATION

This is a Continuation application of a U.S. National Stage under 35 U.S.C 371 of the International Application PCT/CN2019/111908, filed Oct. 18, 2019, which claims priority under 35 U.S.C. 119(a-d) to CN 201910568238.7, filed Jun. 27, 2019.

### BACKGROUND OF THE PRESENT INVENTION

### Field of Invention

The present invention relates to a composition and an application thereof, and more particular to a composition for the treating diabetes based on traditional Chinese medicine nutrition therapy (CMNT) and its application in treating diabetes.

### Description of Related Arts

Diabetes is a global metabolic disorder characterized by persistent hyperglycemia. Diabetes are classified into type I diabetes and type II diabetes: wherein the type I diabetes is an autoimmune disease that causes damage to the pancreatic beta cells, which means that the individual cannot produce sufficient levels of insulin; the type II diabetes is a more complex disease which can be caused by a variety of related diseases, but usually involves resistance to insulin metabolism. For example, type II diabetes is related to age, obesity, and a sedentary lifestyle, all of which can lead to insulin resistance.

With the improvement of people's living standards and the progress of the aging society, the incidence of diabetes is getting higher and higher. According to the International Diabetes Federation (IFD) forecast, the number of people suffering from diabetes worldwide will reach 424.9 million in 2017, and it is estimated that the number of people suffering from diabetes will reach 628.6 million in 2045, of which the number of diabetes patients in China is 114.39 million, accounting for about 27% of the world's diabetes patients. At present, diabetes treatment mainly includes drug therapy, diet therapy, exercise therapy, and cognitive intervention.

Drug therapy mainly uses drugs to promote insulin synthesis and secretion, promoting the effect of peripheral tissues such as muscle, etc. on glucose, thereby inhibiting the uptake of glucose, slowing down the absorption of carbohydrates, or promoting the elimination of blood sugar to reduce the blood sugar content in the body. Drug therapy generally includes chemotherapy and traditional Chinese medicine therapy: chemotherapy, such as some chemical hypoglycemic drugs or insulin, on the one hand, chemical drugs have greater toxic side effects, leading to liver and kidney damage, lactic acidosis, etc.; on the other hand these drugs are generally expensive, and the general public cannot afford the cost of treatment. Chinese medicine therapy, for example a Chinese patent application with a publication number CN109893598A discloses a Chinese medicine composition for lowering blood sugar, which is composed of the following Chinese medicinal materials in parts by weight: 4-10 parts of American ginseng, 5-15 parts of Coptis, 20-40 parts of Astragalus, 15-30 parts of Chinese yam, Chinese wolfberry 10-20 parts, Yuzhu 10-20 parts, Zhimu 10-25 parts. Although the side effects of traditional Chinese medicine therapy are few, the effect of traditional Chinese medicine therapy alone is slow, and if the diet cannot be well controlled at the same time, it will still not have a good effect. Therefore, diet therapy has become another very important, safe and reliable treatment for diabetes.

The first stage of dietary treatment of diabetes is the basic theoretical knowledge education stage, and the second stage is the instructional practice stage of personalized diet therapy. Medical nutrition therapy (Medical Nutrition Therapy, MNT) is an important part of diabetes management, and it is a practical application of evidence-based nutrition consultation and nursing process provided by professionals. The basic components of MNT include evaluation and nutritional diagnosis, intervention measures (such as education and counseling), continuous follow-up monitoring to support long-term lifestyle changes, as well as outcome evaluation and intervention modification, and professional diet planning and regular monitoring, so that patients maintain normal blood sugar levels. However, there is much controversy as to what is the best diet for diabetic patients. Since carbohydrates are the macronutrients that can significantly increase blood sugar levels, the biggest controversy is how low the carbohydrate content of the diet should be. This is because although reducing carbohydrate intake will result in lower blood sugar levels, carbohydrates have traditionally been considered the main energy source for most modern diets, and low-carbohydrate diets may contain increased calories from fat and saturated fat. The recommendation that most people agree with is that the content of sugar and refined carbohydrates in the diet should be low, while the content of dietary fiber, especially soluble fiber, should be relatively high. Similarly, diabetic patients can be encouraged to reduce their intake of carbohydrates with high glycemic index (GI) and therefore follow a low GI diet. A low GI diet is a diet in which food is selected based on the smallest changes in circulating glucose levels. The glycemic index (GI) is a measure of the effect of eating carbohydrate-containing foods on blood sugar levels. A diet of low-glycemic foods has been associated with diabetes management, improved blood lipids (cholesterol), and reduced risk of heart disease.

Unfortunately, a low-GI diet is not easy to achieve because many meals contain refined carbohydrates, such as rice, noodles, and white bread. But the preference for refined rice and refined rice products can make it difficult for diabetics to control their diet, leading to high blood sugar.

Patent document CN108697145A discloses a high-grade food material in the form of a composition for lowering the glycemic index of food, and specifically but not exclusively a complex comprising the composition and the food, the composition comprising The composition is 40% to 80% by weight of insoluble resistant starch; soluble fiber; and at least one carbohydrate enzyme inhibitor, or consists of these substances. The glycemic index of the food is advantageously reduced by adding the material. Specifically, it is a composite material that can reduce the blood glucose index of foods. It can control blood glucose levels by reducing the blood glucose index of foods. This does not reduce the blood glucose levels of diabetic patients and regulate the insulin levels and insulin resistance in patients. The role of sex and β-cell function, so it does not play a role in the treatment of diabetes, can only prevent the increase in blood sugar to a certain extent.

Based on the current status and deficiencies of current diabetes treatment methods, the present invention intends to propose a dietary therapy method for diabetes based on traditional Chinese medicine nutritional therapy, and specifically relates to a composition or food for the treatment of diabetes based on traditional Chinese medicine nutritional therapy and its application.

### SUMMARY OF THE PRESENT INVENTION

The technical problem to be solved by the present invention is to provide a composition for the treating diabetes based on traditional Chinese medicine nutrition therapy (CMNT) and its application in the treatment of diabetes.

The Chinese Medical Nutrition Therapy (CMNT) proposed in the present invention refers to the medical nutrition therapy (Medical Nutrition Therapy, MNT) basis, guided by the theory of Chinese medicine, by adding traditional Chinese medicine nutrition and trace elements of the same medicine and food as an intervention method to change personal nutritional status to improve health or treat diseases. Under the guidance of the basic theories of traditional Chinese medicine, the concept of holistic concept, medicine and food from the same source, and diet based on syndromes is implemented, and the principles of scientific proportions, proper food intake, and balance of nature and taste are followed. It is a diet structure and intermittent system that emphasizes low glycemic index (GI), low calories, low available carbohydrates, high unsaturated fatty acids, high dietary fiber, and high medicinal and food homology. Sexual fasting diet is a way to treat diabetes.

In order to solve the above technical problems, the present invention adopts the following technical solutions.

A composition for treating diabetes based on traditional Chinese medicine nutritional therapy, wherein the composition is a low GI composition, and the composition comprises available carbohydrates, fat, protein, and dietary fiber and Chinese medicine extract components; wherein as a dosage of the composition for a day, an amount of dietary fiber presented in the composition is at a range of 10-40 g; a total energy of the composition is at a range of 400-1300 calories, wherein energy provided by the carbohydrates is 15-45% of a total energy of the composition; the energy provided by the fat is 40-80% of a total energy of the composition, and a mass fraction of unsaturated fatty acids takes 50-80 of a total mass of the fat, energy provided by an amount of protein takes 5-15% of the total energy of the composition; raw materials of the composition comprises 1-5 g of the Chinese medicine extract components;

wherein specifically, when applied, the composition is a solid food formed by processing multiple natural raw materials containing raw materials with auxiliary materials; wherein the solid food comprises breakfast, first dinner 1 and second dinner which are used in combination, wherein parts below is calculated by weight,

wherein the breakfast comprises 30-40 parts of fruit and vegetable porridge; the first dinner comprises 80-85 portions of nutritional rice and 30-35 parts of functional drink; the second dinner comprises 20-25 parts of biscuits and 30-35 parts of functional drink;

wherein the functional drink is a microcapsule powder corresponding to the fat, which is prepared by adding auxiliary materials to raw fats and fats derived from unsaturated fatty acids in the fat;

wherein the fruit and vegetable porridge is prepared by mixing fruit and vegetable powder prepared from the fruit and vegetable components in a carbohydrate source material with the functional beverage, and a mass ratio of the fruit and vegetable powder to the functional beverage is 1:1;

wherein the nutrient rice is prepared by mixing grain components and the traditional Chinese medicine extract components in the raw materials of carbohydrates, extruding and granulating; wherein a mass ratio of the grain components to the traditional Chinese medicine extract components is (30-80): (5-20);

wherein the biscuits are prepared by using fruit and vegetable components and grain components in carbohydrate source raw materials, as well as raw materials of the same medicine and food and adding auxiliary materials;

wherein in addition, the composition is applied to a diet of diabetic patients in an intermittent fasting diet; wherein the intermittent fasting diet specifically comprising: taking a first 2-8 days in each treatment cycle as a treatment period, during the treatment period, the composition is continuously used as the diet by the diabetic patients; taking a next 5-30 days as an intermittent period during which diet is free to eat.

In the above scheme:

The term “available carbohydrates” refers to carbohydrates that can be digested and absorbed by the human body. Because they are absorbed into the blood and can cause blood sugar levels to rise, they are also called glycaemic carbohydrates. Available carbohydrates mainly include sugar, starch (except resistant starch) and some sugar alcohols (polyol) that have the effect of promoting blood sugar.

The term “unsaturated fatty acid” means that fatty acids other than saturated fatty acids are unsaturated fatty acids. Fatty acids without double bonds are called saturated fatty acids. The main fatty acids in all animal oils are saturated fatty acids, except for fish oil.

The term “dietary fiber” is a polysaccharide, which can neither be digested and absorbed by the gastrointestinal tract, nor can it produce energy. There are two main types of dietary fiber: soluble dietary fiber and insoluble dietary fiber. Soluble dietary fiber mainly comes from pectin, algin, konjac, etc.; the best source of insoluble dietary fiber is whole grains, including wheat bran, oatmeal, whole wheat flour and brown rice, oats and whole grains, beans, vegetables and fruits Wait.

The term “medicine and food homologous” refers to food that is both food and medicine. The “Notice on Further Regulating the Management of Health Food Raw Materials” published by the Ministry of Health has specific provisions for medicinal and food homologous items. The examples in the present invention are The raw materials of the same medicine and food are all items specified in the “Notice”.

The term “glycemic index GI”: the change in blood glucose concentration over a period of time after a meal caused by the human body eating a certain amount of test food is called the blood glucose response. Glycemic index (GI) refers to the increase in the area under the blood glucose response curve (incremental area) within 2 hours after fasting for 12 hours and ingesting a test substance containing a certain target amount (usually 50 g) of available carbohydrates. The ratio of the area under the glucose response curve of a reference substance contains same amount of available carbohydrates to the area under the glucose response curve. The average GI value is calculated from data collected from 10 human individuals. The test substance and the reference substance must contain the same amount of available carbohydrates. The GI value can be interpreted as an absolute percentage relative to glucose, and is usually interpreted as follows:
If GI≤55, the food is low GI food;
If 55<GI≤70, the food is medium GI food;
If GI>70, the food is high GI food.

As those skilled in the art know, low-GI foods will release glucose more slowly and steadily, which leads to more appropriate postprandial or after meal blood glucose readings. High GI foods can cause blood sugar levels to rise more quickly. The term “calorie” refers to food calories.

The raw material extracts in the plan include: fat sources, especially sources of unsaturated fatty acids, including oils extracted from certain natural raw materials, for example: pumpkin kernel oil is a kind of oil extracted from natural raw pumpkin kernels Extracts; raw materials of medicine and food, including extracts extracted from raw materials, such as lily extract, yam extract, chrysanthemum extract, cassia seed extract, etc.

Since different kinds of available carbohydrates, fats, proteins and other components provide different energy, in this program, in order to strictly control the energy supply of the composition per day (the energy of the composition per day is 400-1300 calories), it is combined The main energy-supplying components in the carbohydrates, fats, and proteins can be used to limit the composition of the composition with the energy-supply ratio. In the actual application process, those skilled in the art can use the mass-energy conversion standards generally recognized in the field to determine the composition of the composition. The amount of available carbohydrates, fats, proteins and other compound components in each raw material can be used to obtain the energy supply and energy supply ratio of each component; conversely, the available carbohydrates in the composition can also be calculated based on the energy supply. Fat, protein, etc. In the present invention, the conversion standard specifically refers to the conversion of the energy provided per 100 g of available carbohydrates, fats, and proteins according to 400 kcal, 900 kcal, and 400 kcal, respectively. For example: Provide a composition, the daily amount of composition energy is 1000 calories, the energy requirement provided by the amount of available carbohydrates in the raw materials is controlled at 40%, that is, 400 calories, then according to the conversion standard, the corresponding available carbon water The amount of compound present is 100 g.

The microcapsule powder in the above scheme is a microcapsule powder oil product. “Microcapsule powder” is also called “microcapsule powder”. It is formed by using microcapsule technology to wrap solid, liquid or gaseous substances with high-quality wall materials. A powdery substance. The diameter is generally 1-500 μm, and the thickness of the wall is generally 0.5-150 μm, which can improve the stability of the product, prevent mutual interference between various components, and is easier for the body to absorb and use. The unsaturated fatty acid raw material oil in the fat source in the composition is made into microcapsule powder through microencapsulation technology, and then the nutrient rice and biscuits are used in combination, which can better help the human body to absorb various ingredients in the raw material And use.

The above-mentioned composition for treating diabetes based on traditional Chinese medicine nutritional therapy provided by the present invention should be applied to the diet of diabetic patients in an intermittent fasting diet. Specifically, in each treatment cycle, the first 2-8 days are used as the treatment period, during the treatment period, the composition/food is continuously used as the diet of diabetic patients or added to the diet; the last 5-30 days are used as the intermittent period, Free eating during the intermittent period.

Preferably, the intermittent fasting diet includes but is not limited to the following:

Take 11 days as a cycle, and the first 5 days as the treatment period. During the treatment period, the composition/food is continuously used as the diet of diabetic patients or added to the diet; the last 6 days are used as the intermittent period, and the intermittent period is free to eat.

Take 15 days as a cycle, and the first 5 days as the treatment period. During the treatment period, the composition/food is continuously used as the diet of diabetic patients or added to the diet; the next 10 days are used as an intermittent period, with free eating during the intermittent period.

Take 30 days as a cycle, the first 5 days as the treatment period. During the treatment period, the composition/food is continuously used as the diet of diabetic patients or added to the diet; the last 25 days are used as an intermittent period, with free eating during the intermittent period.

Take 14 days as a cycle, the first 7 days are the treatment period, during the treatment period, the composition/food is continuously used as the diet of the diabetic patient or added to the diet; the last 7 days are used as the intermittent period, and the intermittent period is free to eat.

Specifically, as a preferred embodiment, in the food, in parts by weight:

The breakfast includes 30-40 portions of fruit and vegetable porridge; the first meal includes 80-85 portions of nutritional rice and 30-35 portions of functional drinks; the second meal includes 20-25 portions of biscuits and 30-35 portions of functional drinks;

The functional beverage is a pumpkin kernel oil microcapsule powder prepared by adding auxiliary materials to pumpkin kernel oil, which is a fat source raw material;

The fruit and vegetable porridge is prepared by mixing the fruit and vegetable powder prepared by using the fruit and vegetable components in the carbohydrate source raw materials, dehydrated carrot powder, dehydrated cucumber powder, and dehydrated spinach powder, and the functional drink, and the mass ratio of the fruit and vegetable powder to the functional drink is 1:1;

The nutrient rice is prepared by mixing oat powder and ginseng extract, which are grain components in raw materials from carbohydrate sources, and extruding and granulating; the mass ratio of oat powder and lily powder is (30-80): (5-20);

The biscuit is prepared by adding at least one of the fruit and vegetable ingredients dehydrated carrot powder, dehydrated cucumber powder, and dehydrated spinach powder in carbohydrate source raw materials, oat powder with grain components, and lily powder, which is a raw material of the same food and medicine.

In order to meet the needs of diabetic patients for a normal three-meal diet, the composition is a solid form of food formed by processing a variety of natural raw materials including medicinal and edible homologous raw materials with auxiliary materials, and is prepared according to the daily dosage. The forms of breakfast, first dinner and second dinner are used together. The fruit and vegetable porridge, functional drinks, biscuits and nutritious rice in this preferred embodiment are all in solid form. Among them, the fruit and vegetable porridge and functional beverage are in solid powder form; the solid form and liquid form prepared based on the same raw materials and similar proportions are matched Products or products provided in liquid form are all within the protection scope of the present invention.

The above-mentioned intermittent application method is specifically determined according to the different conditions of the patient. The beneficial effects of the present invention:

1. The present invention proposes a regimen for the treatment of diabetes based on the nutritional therapy of traditional Chinese medicine. The composition proposed for the treatment of diabetes emphasizes low glycemic index (the GI value of daily food is less than 55) and low calorie (daily food). The total energy of the composition is 400-1300 calories), low-available carbohydrates (the energy provided by the available carbohydrates in the raw materials accounts for 15-50% of the total energy of the composition raw materials per day) and highly unsaturated fatty acids (in the raw materials) The content of unsaturated fatty acids accounts for 50-80% of the total fat of the daily composition raw materials), high dietary fiber (the amount of dietary fiber is 10-40 g, which accounts for more than 10% of the total weight of the daily composition), high-drug Food homology (10-30 g of raw materials of medicine and food homology, accounting for more than 5% of the total mass of the composition per day) “three lows and three highs” diet structure, and add traditional Chinese medicine extract ingredients. At the same time, combined with the intermittent fasting diet, specifically the first 2-8 days as the treatment period, during the treatment period, the diet/food is continuously used as the diet of the diabetic patient or added to the diet; the next 5-30 days as the treatment period The intermittent period, free eating during the intermittent period, combined with this intermittent fasting diet to achieve the reduction of blood sugar levels in diabetic patients.

2. The composition provided by the present invention controls the proportion of energy provided by available carbohydrates, and replaces part of the available carbohydrates with high fat, especially unsaturated fatty acids, to provide the required energy. On the one hand, it can better achieve a low diet. GI, and the unsaturated fatty acid itself can reduce the probability of diabetes, indicating that the unsaturated fatty acid itself can have a certain preventive effect on diabetes and can regulate the metabolism of blood sugar. At the same time, the composition of the present invention has relatively high dietary fiber in raw materials. Studies have shown that regular intake of sufficient dietary fiber can reduce the all-cause mortality of diabetic patients. The recommended dietary fiber intake for diabetic patients is at least 14 per 4186 kJ. g fiber, and compared with dietary supplement supplements, foods rich in dietary fiber naturally contain micronutrient elements and plant active ingredients. The dietary fiber in the composition of the present invention is mainly derived from grain raw materials rich in dietary fiber, so it can It can better regulate blood sugar metabolism in diabetic patients, but high dietary fiber intake may cause flatulence, bloating and diarrhea.

The theory of traditional Chinese medicine believes that improper diet can cause damage to the spleen and stomach, block the flow of water and grains, stop the accumulation of water and dampness, produce phlegm turbidity, breed phlegm dampness and internal heat, and the internal resistance of phlegm heat is diminished thirst (type II diabetes). In the early stage of diabetes, the main manifestation is heat. With the development of the disease, it changes from actual heat to deficiency heat, and signs of deficiency of qi, yin, yang, and yin and yang are present, that is, fiery heat at the initial stage and deficiency of both qi and yin in the middle stage. Yin damage and lack of Yang Qi in the later period. The composition or food of the present invention adds medicinal and food homologous nutrition and traditional Chinese medicine extract ingredients, combined with intermittent fasting, not only can effectively protect the spleen and stomach functions, but also can avoid the intake of high dietary fiber in medical nutrition treatment The resulting symptoms of flatulence, bloating and diarrhea protect the health of the intestines.

Although the GI diet is difficult to achieve in the prior art, the present invention mainly uses low-available carbohydrates and high-fat to provide energy, and controls the content of unsaturated fatty acids in fat and the content of dietary fiber in the composition, and at the same time Adding raw materials of the same source of medicine and food, preferably adding the components of traditional Chinese medicine extracts, while ensuring a low GI diet, achieves the effects of controlling the blood glucose level of diabetic patients and regulating the blood glucose metabolism of patients.

3. The present invention is based on the nutritional treatment method of traditional Chinese medicine which can effectively reduce the blood sugar level of diabetic patients. On the one hand, the food proposed in the plan consists of breakfast, dinner one, and dinner two, which itself conforms to the diet structure of diabetic patients and can realize the diet of patients Good control, so as to better adhere to the treatment and get a better treatment effect; on the other hand, the sources of these compositions/foods are mainly natural fruits, vegetables, grains or their processed products. Compared with chemical treatment, the treatment cost is lower and safer Reliable, no toxic side effects.

### BRIEF DESCRIPTION OF THE DRAWINGS

In order to explain the embodiments of the present invention or the technical solutions in the prior art more clearly, the following will briefly introduce the drawings that need to be used in the description of the embodiments or the prior art. Obviously, the drawings in the following description are only These are some embodiments of the present invention. For those of ordinary skill in the art, other drawings can be obtained based on these drawings without creative work.

FIG. 1a, 1b, and 1c are comparison diagrams of the ratio of pancreatic islet β cells, a comparison diagram of proliferating cells, and a comparison diagram of β cells/proliferating cells between the control group and the treatment group, respectively.

FIGS. 2a, 2b, and 2c are diagrams showing the comparison of the ratio of pancreatic islet β cells, the ratio of a cells, and the ratio of α/β cells in the control group and the treatment group, respectively.

FIGS. 3a and 3b are comparison diagrams of the results of HOMA-B and HOMA-IR of the control group (C) and the treatment group (T), respectively.

FIGS. 4a, 4b, 4c, and 4d are the malondialdehyde (MDA), superoxide dismutase (SOD), catalase (CAT) and gluten in the liver of the small treatment group (T) and the control group (C), respectively. Concentration level comparison chart of glutathione peroxidase (GSH-Px).

FIG. 5a is a comparison chart of drug withdrawal rates after intervention between the CMNT group and the regular diet group; FIG. 5b is a comparison chart of the results of glycosylated hemoglobin before and after intervention in the CMNT group and the regular diet group.

FIG. 6 is a comparison diagram of the effects of multiple rounds of CMNT simulated fasting and non-fasting phases in diabetic subjects.

FIG. 7 is a comparison chart of the fasting blood glucose distribution of subjects before and after intervention.

### DETAILED DESCRIPTION OF THE PREFERRED EMBODIMENT

The preferred features of each aspect of the invention can be described in conjunction with any other aspect.

Other features of the present invention will be understood from the following examples. Generally speaking, the present invention extends to any one novel feature or any combination of novel features disclosed in this specification (including the appended claims and drawings). Therefore, a feature, integer, characteristic, compound or chemical part described in conjunction with a particular aspect, embodiment, or example of the present invention should be understood to be applicable to any other aspect, embodiment, or example described herein, unless it is similar to it. contradiction.

Moreover, unless otherwise stated, any feature disclosed herein may be replaced by an alternative feature that achieves the same or similar purpose.

In the following embodiments, when calculating the energy composition, the energy provided by each 100 g of available carbohydrates, fats, and proteins is converted into 400 kcal, 900 kcal, and 400 kcal, respectively.

The term “fasting blood glucose level” refers to the level of glucose in the blood of a subject after 8 hours of fasting. A person's normal fasting blood glucose blood level is less than 100 mg/dL (for example, 70 to 99 mg/dL).

The present invention provides a composition for the treatment of diabetes based on the nutritional therapy of traditional Chinese medicine. The composition is a low GI composition, and the composition contains a variety of available carbohydrates, fats, proteins, and dietary fibers. Compound components, including Chinese medicine extract components;

On a daily basis, the amount of dietary fiber present in the composition is at a range of 10-40 g, which can be specifically, but not limited to, 10, 10.5, 11, 11.5, 12, 12.5, 13, 13.5, 14, 15, 16, 17, 18, 19, 20, 21, 22, 23, 24, 25, 26, 27, 29, 30, 32, 33, 34, 35, 36, 37, 38, 39, 40 g.

The total energy of the composition is 400-1300 calories, of which:

The energy provided by the amount of available carbohydrates is 15-45% of the total energy of the composition; specifically, it can be but not limited to 15%, 16%, 17%, 18%, 19%, 20%, 21%, 22%, 23%, 24%, 25%, 26%, 27%, 29%, 30%, 32%, 33%, 34%, 35%, 36%, 37%, 38%, 39%, 40%, 41%, 42%, 43%, 44%, 45%.

The energy provided by the amount of fat present is 40-80% of the total energy of the composition, which can be specifically but not limited to 40%, 45%, 50%, 55%, 65%, 70%, 75%, 80%; wherein: The mass of unsaturated fatty acids is 50-80% of the total mass of fat, which can be specifically but not limited to 50%, 52%, 55%, 58%, 60%, 62%, 65%, 67%, 70%, 72%, 76%, 79%, 80%.

The energy provided by the amount of protein is 5-15% of the total energy; specifically, it can be, but not limited to, 5%, 6%, 7%, 8%, 9%, 10%, 11%, 12%, 13%, 14%, 15%.

The raw material of the composition contains 1-5 g of Chinese medicine extract components; specifically, it can be, but not limited to, 1, 1.5, 1.8, 2, 2.5, 2.9, 3, 3.2, 3.6, 4, 4.2, 4.5, 4.8, 5 g.

Specifically, when the composition is applied, it is a food in a solid form formed by processing the above-mentioned multiple natural raw materials containing the same medicinal and edible raw materials with auxiliary materials; the food includes breakfast, dinner 1 and dinner 2 used in combination, In parts by weight,

The breakfast includes 30-40 portions of fruit and vegetable porridge; the first meal includes 80-85 portions of nutritional rice and 30-35 portions of functional drinks; the second meal includes 20-25 portions of biscuits and 30-35 portions of functional drinks;

The functional beverage is a microcapsule powder corresponding to the fat, which is prepared by adding auxiliary materials to raw fats and fats derived from unsaturated fatty acids in fat;

The fruit and vegetable porridge is prepared by mixing fruit and vegetable powder prepared from the fruit and vegetable components in the carbohydrate source material with the functional beverage, and the mass ratio of the fruit and vegetable powder to the functional beverage is 1:1;

The nutrient rice is prepared by mixing grain components and traditional Chinese medicine extract components in raw materials of carbohydrates, extruding and granulating; the mass ratio of grain components and traditional Chinese medicine extract components is (30-80): (5-20);

The biscuits are prepared by using fruit and vegetable components and grain components in carbohydrate source raw materials, as well as raw materials of the same medicine and food and adding auxiliary materials;

In addition, the composition is applied to the diet of diabetic patients in an intermittent fasting diet; the intermittent fasting diet specifically refers to the first 2-8 days in each treatment cycle as the treatment period, During the treatment period, the composition is continuously used as a fasting diet for diabetic patients; the next 5-30 days is used as an intermittent period, and the intermittent period is free to eat. The intermittent fasting diet includes but is not limited to: taking 11 days as a cycle, the first 5 days as the treatment period, and the last 6 days as the intermittent period; taking 15 days as a cycle, the first 5 days as the treatment period, and the latter 10 days as the intermittent period; 30 days as a cycle, the first 5 days as the treatment period, and the last 25 days as the intermittent period; 14 days as a cycle, the first 7 days as the treatment period, and the last 7 days as the intermittent period.

In the embodiment of the present invention:

The raw material sources of the available carbohydrates include, but are not limited to: mushrooms, rice heads, green onions, leeks, amaranth, konjac, celery, burdock, asparagus, black fungus, wax gourd, leaf add vegetables, loquat vegetables, Chinese kale, vegetables Moss, common cabbage, rutabaga, cabbage, cauliflower, Brussels sprouts, broccoli, bulb sprouts, Chinese cabbage, leaf mustard, loquat mustard, stem mustard, shepherd's purse, long pepper, sweet pepper, toon, garland chrysanthemum, Bittern, taro, coriander, winter squash, zucchini, cucumber, artichoke, carrot, lentil, water chestnut, edamame, day lily, Jerusalem artichoke, hericium, waterweed, lettuce, head lettuce, squash lettuce, gourd, Shiitake mushrooms, loofah, tomatoes, winter cold vegetables, bitter gourd, lotus root, jicama, kidney beans, bamboo shoots, peas, oyster mushrooms, radishes, edible rhubarb, Ci mushroom, potato, eggplant, grass silkworm, spinach, white fungus, snake gourd, Tricholoma, Broad Bean, Cowpea, Straw Mushroom, Rice White, Tomato, Cabbage, Potato, Carob, Pumpkin, Garlic, Cauliflower, Onion, Japonica Rice, Indica Rice, Glutinous Rice, Purple Rice, Barley, Wheat, Highland Barley, Buckwheat, Naked Oats One or more of, corn, millet, millet, millet, millet, sorghum, soybean, mung bean, peas, broad bean, green bean, cowpea, black bean.

Specifically, mushrooms, green onions, leeks, broccoli, brussels sprouts, broccoli, cabbage, Chinese cabbage, loofah, tomato, etc. in the above-mentioned sources are fruit and vegetable ingredients recognized by the public. Among the above-mentioned sources, japonica rice, indica rice, barley, Rice, beans, and wheat such as wheat, corn, millet, soybeans, and mung beans are cereal ingredients.

The raw material sources of the unsaturated fatty acids in the fat include but are not limited to: grape seed oil, pumpkin kernel oil, grape seed oil, coconut oil, olive oil, wheat oil, sunflower oil, safflower seed oil, rapeseed oil, corn One or more of oil, peanut oil, hemp oil, camellia oil, tea seed oil, rice oil, walnut oil, pepper oil, lavender oil, linseed oil, perilla oil, and canola oil.

Sources of raw materials of the same food and medicine include, but are not limited to: cloves, star anise, canavalia, fennel, thistle, yam, hawthorn, purslane, black snake, ebony, papaya, hemp seed, daidai Flower, polygonatum, licorice, angelica, ginkgo, white lentils, white lentil flowers, longan flesh, cassia, lily, nutmeg, cinnamon, emblic, bergamot, almond, sea buckthorn, oyster, ginseng, pepper, red bean, donkey-hide gelatin, chicken Inner gold, malt, kelp, jujube, Luo Han Guo, Yu Li Ren, honeysuckle, green fruit, Houttuynia cordata, ginger, Hovenia dulcis, medlar, gardenia, amomum, stubby, tuckahoe, citron, incense, peach kernel, mulberry leaf, Mulberry, orange red, platycodon, nootropic kernel, lotus leaf, raisin seed, lotus seed, galangal, light bamboo leaf, light tempeh, chrysanthemum, chicory, yellow mustard seed, polygonatum, perilla, perilla seed, kudzu root, black sesame, Black pepper, Sophora japonica, Sophora japonicus, dandelion, honey, torreya, wild jujube seed, fresh white grass root, fresh reed root, agkistrodon, orange peel, mint, coix seed, scallion white, raspberry, ageratum, ginseng, mountain silver flower One or more of, coriander, rose, pine pollen, Chinese pine, kudzu, cloth residue leaves, prunella vulgaris, angelica, saffron, saffron, grass fruit, turmeric, tuber long, or corresponding to the natural raw material One or more of the extracts.

The raw material sources of Chinese medicine extract components include but are not limited to: Ganoderma lucidum polysaccharides, Cordyceps extract, Luo Han Guo extract, Scutellaria baicalensis extract, Panax notoginseng extract, Perilla seed extract, Ginseng extract, Sophora flavescens extract, Burdock seed extract Ingredients, ginger extract, tangerine peel extract, wolfberry extract, Codonopsis pilosula extract, astragalus extract, eucommia extract, honeysuckle extract, grape seed extract, Citrus aurantium extract, white willow bark extract, motherwort extract, Polygonatum Extract, Atractylodes Rhizome extract, Salvia miltiorrhiza extract, Shandou root extract, Sophora japonica extract, Licorice extract, Coptis extract, Polygonum multiflorum extract, Pulsatilla extract, Rhubarb extract, Poria extract, Aloe extract, Dandelion extract, Pueraria lobata root extract, Hawthorn extract, Houttuynia cordata extract, Polygonatum odoratum extract, Green leaf extract, Radix isatidis extract, Lotus leaf extract, Bupleurum extract, Forsythia extract, Bitter melon extract One or more of extracts, Acanthopanax senticosus extract, olive extract, Gynostemma pentaphyllum extract, Moringa extract, Paeonia suffruticosa extract, Silybum marianum extract, Viola odorifera extract.

The following specific examples illustrate various embodiments of the present invention, and those skilled in the art recognize that the spirit of the present invention can make many variations within the scope of the claims.

In order to better illustrate the effect of the present invention, the embodiments of the present invention provide a CMNT-based composition for the treatment of diabetes, which is a solid form of food formed by adding auxiliary materials to a variety of natural raw materials containing raw materials of the same medicine and food. And according to the daily consumption, it is made into the form of breakfast, meal one and meal two to be used together. It includes the following parts by weight:
Breakfast: 40 pieces of fruit and vegetable porridge
Dinner 1: 85 servings of nutritional rice, 35 servings of functional drinks
Dinner 2: 20 biscuits, 35 functional drinks.

This embodiment provides food, the composition of raw materials by weight of breakfast, meal one, and meal two, the content and energy composition of available carbohydrates, fat, protein, and dietary fiber contained in the raw materials, and the available carbon water in the daily amount The content and energy composition of compounds, fat, protein and dietary fiber are as follows: Table 1.1-1.4:

TABLE 1.1
The composition of the ingredients by weight of the breakfast and the
corresponding ingredients and energy composition of the ingredients
Available carbohydrates (g) Fat (g) Protein (g) Dietary fiber (g)

| | | Available | | | Dietary |
|---|---|---|---|---|---|
| | Dosage | carbohydrates | Fat | Protein | fiber |
| Breakfast | (g) | (g) | (g) | (g) | (g) |
| Pumpkin powder | 10 | 6.81 | 0.21 | 0.71 | 1.15 |
| Pumpkin | 10 | / | 10 | / | / |
| Kernel Oil | | | | | |
| β -cyclodextrin | 12.5 | / | / | / | / |
| Gelatin | 2.5 | / | / | / | / |
| Konjac flour | 5 | / | / | / | 4.5 |
| Total | 40 | 6.81 | 10.21 | 0.71 | 5.65 |
| Energy kcal | 121.97 | 27.24 | 91.89 | 2.84 | / |

TABLE 1.2
The composition of the raw materials in parts by weight
of a first dinner and the corresponding components
and energy composition of the raw materials

| | | Available | | | Dietary |
|---|---|---|---|---|---|
| | Dosage | carbohydrates | Fat | Protein | fiber |
| First dinner | (g) | (g) | (g) | (g) | (g) |
| Rice noodle | 28.00 | 21.50 | 0.17 | 2.16 | 0.17 |
| Flour | 3.50 | 2.50 | 0.05 | 0.39 | 0.07 |
| Oat | 35.00 | 21.56 | 2.35 | 5.25 | 1.86 |
| Ginseng | 7.00 | 3.97 | 0.30 | 0.26 | 0.15 |
| extract | | | | | |
| Corn flour | 3.50 | 2.34 | 0.16 | 0.28 | 0.22 |
| Pumpkin | 14.00 | / | 14.00 | / | / |
| Kernel Oil | | | | | |
| Inulin | 5.00 | / | / | / | 4.50 |
| Soy Protein | 10.00 | / | / | 9.00 | / |
| Total | 106.00 | 51.88 | 17.03 | 17.34 | 6.96 |
| Energy kcal | 430.11 | 207.51 | 153.23 | 69.37 | / |

Soy Protein
total
Energy kcal

TABLE 1.3
The composition of the raw materials by weight of
the second dinner and the corresponding components
and energy composition of the raw materials

| | | Available | | | Dietary |
|---|---|---|---|---|---|
| | Dosage | carbohydrates | Fat | Protein | fiber |
| Second dinner | (g) | (g) | (g) | (g) | (g) |
| Dehydrated | 2 | 1.43 | 0.038 | 0.084 | 0.128 |
| carrot | | | | | |
| powder | | | | | |
| Dehydrated | 2 | 1.108 | 0.0924 | 0.3696 | 0.231 |
| cucumber | | | | | |
| powder | | | | | |
| Dehydrated | 2 | 1.26 | 0.012 | 0.128 | 0.254 |
| spinach | | | | | |
| powder | | | | | |
| Oatmeal | 2 | 1.232 | 0.134 | 0.3 | 0.106 |
| Quinoa | 4 | 2.176 | 0.108 | 0.388 | 0.232 |
| wheat | 4 | 2.86 | 0.06 | 0.448 | 0.084 |
| lily | 2 | 1.522 | 0.01 | 0.134 | 0.034 |
| Skimmed | 2 | 1.4275 | 0 | 0.502 | 0 |
| milk | | | | | |
| powder | | | | | |
| Pumpkin | 14 | / | 14 | / | / |
| Kernel Oil | | | | | |
| total | 34 | 13.0155 | 14.4544 | 2.3536 | 1.069 |
| Energy kcal | 191.566 | 52.062 | 130.0896 | 9.4144 | / |

TABLE 1.4
The mass composition and energy composition
of each ingredient in a day's food

| | | Available | | | Dietary |
|---|---|---|---|---|---|
| | Dosage | carbohydrates | Fat | Protein | fiber |
| A day | (g) | (g) (g) | (g) | (g) | (g) |
| quality | 180.00 | 71.70 | 41.69 | 20.41 | 13.68 |
| Energy | 743.64 | 286.81 | 375.21 | 81.62 | 0.00 |
| kcal | | | | | |
| Energy | / | 41.57% | 54.38% | 11.83% | / |
| ratio | | | | | |

It can be seen from the above table that, among the total energy of the food in this embodiment, available carbohydrates provide 41.57%, fats provide 54.38%, and proteins provide 11.83%. The GI value of this food is 46.3.

The preparation method of the functional drink described in this embodiment is as follows:

(1) Preparation of wall material: add 50 parts of β-cyclodextrin to deionized water, heat the water bath to 40-50° C., then add 10 parts of gelatin, and keep stirring until there is no obvious insoluble matter to obtain the wall material solution; β—The ratio of cyclodextrin to deionized water is 1:5;

(2) Preparation of microcapsules: After the wall material solution in step (1) is cooled to room temperature, add 40 parts of pumpkin kernel oil and put it in a homogenizer for homogenization. The temperature of the homogenizer is controlled at 40-50° C. and the pressure Control at 20-30 MPa;

The pumpkin kernel oil of this embodiment is prepared by the extraction method disclosed in the patent document CN201110066333.0, and the content of unsaturated fatty acids in the pumpkin kernel oil is 74%.

(3) Put the obtained homogeneous mixture solution in a refrigerator at 2-6° C. for 10-12 h, and then dry for 12-24 h to obtain pumpkin kernel oil microcapsules. The functional drink is obtained after vacuum packaging.

The preparation method of the fruit and vegetable porridge described in this embodiment is as follows:

(1) Dry 50 parts of dehydrated carrot powder, dehydrated cucumber powder, and dehydrated spinach powder to make the moisture content within 10%, and then crush the dried fruits and vegetables to 200 meshes to make fruit and vegetable powder;

(2) Mix the fruit and vegetable powder in step (1) with the functional drink according to a certain mass ratio of 1:1 to make fruit and vegetable porridge.

The method for preparing nutritious rice in this embodiment is as follows:

Mix 50 parts of oat flour and 10 parts of traditional Chinese medicine extract ginseng extract, 40 parts of rice flour, 5 parts of flour, and 5 parts of corn flour in the available carbohydrate raw materials; the mixture is adjusted through the feeding device. The high-quality materials are sent to the twin-screw extrusion granulator for extrusion granulation; then they are cooled by a rice cooler, and then dried by a microwave dryer. The microwave frequency is set at 1000-2000 MHZ, and the material at the microwave outlet is controlled. The moisture content is 8-14.5%, and then it is cooled by two rice coolers, and finally it is graded and packaged into finished products.

The preparation method of the biscuit in this embodiment is as follows:

(1) After drying 40 portions of available carbohydrate raw materials with fruit and vegetable components, dehydrated carrot powder, dehydrated cucumber powder, dehydrated spinach powder, grain component oat powder, and lily powder, which is a raw material of the same kind of medicine and food, put it into a high-speed tissue masher. Treat it for 10-20 min under the condition of rotation speed of 1200-1500 rpm to make powder, ready for use;

(2) Mix 20 parts of quinoa flour, 20 parts of wheat flour and 10 parts of skimmed milk powder, then knead the egg yolk and make it even;

(3) Pour the water into the fruit and vegetable powder and grain powder mixture and stir evenly, then add salt and baking soda, and finally add butter and stir evenly;

(4) Mix and knead the raw materials of the above steps (2) and (3) at 23-26° C. to prepare a dough;

(5) Roll forming, baking and cooling to make finished products.

The following experiments will verify the therapeutic effect of the composition for the treatment of diabetes based on the nutritional therapy of Chinese medicine provided by the present invention on the intervention of diabetes:

1. Mouse Experiment

For the mouse experiment, the composition provided by the present invention is converted into the consumption of the mouse to perform the mouse experiment. The animal experiment on diabetic mice is specifically as follows. The experiment is divided into two groups:

Treatment group: db/db mice (20 mice), treated in a cycle of 11 days, treated with CMNT in the advanced behavior stage for 5 days, and freely fed for 6 days, for a total of 7 cycles of treatment.

Control group: db/db mice (20), free to eat, and fed with the same amount of normal mouse feed.

During the 5-day CMNT treatment phase, 1.635 g of CMNT food was fed every day, and the control group was fed the same amount of normal mouse feed during the free fasting phase. Before normal mouse feed or CMNT feeding, it is necessary to feed the mice for 14 days in the experimental environment to adapt the mice to the growth environment.

1. Experiments to Promote β Cell Regeneration

In this experiment, after the end of the three intervention cycles, 8 mice in the control group and the treatment group were taken, 15 islets sliced for each islet, and the data of each islet was taken as the average of all the islet slices for each islet.

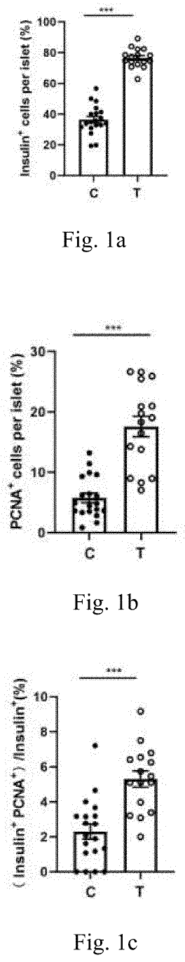

(1) Pancreatic sections were stained with anti-insulin antibody and Proliferating Cell Nuclear Antigen (PCNA). The nucleus was stained with DAPI. The ratio of islet β cells, the ratio of proliferating cells, and the ratio of β cells to proliferation of mouse pancreatic islets were measured. The results are shown in FIGS. 1a, 1b, and 1c. FIGS. 1a, 1b, and 1c are the ratio of islet β cells in the control and treatment groups, respectively. Proliferation cell ratio, β cell/proliferation cell ratio comparison.

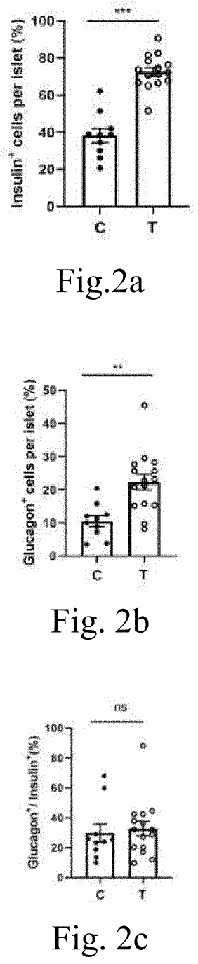

(2) Pancreatic sections were stained with anti-insulin antibody and anti-glucagon antibody. The nucleus was stained with DAPI. The proportions of pancreatic islet β cells, a cells and α/β cells were measured, and the results are shown in FIGS. 2a, 2b, and 2c. FIGS. 2a, 2b, and 2c are the proportion of islet β cells and a cells in the control group and the treatment group, respectively. Ratio, a/β cell ratio comparison.

In the figure, *p<0.05, **p<0.01, ***p<0.001; in the figure, group C represents the control group, and group T represents the treatment group (CMNT).

The comparison of the results showed that the treatment group (CMNT) could reverse β cell failure by promoting β cell proliferation.

2. Beta Cell Function Improvement and Insulin Resistance Improvement Experiment

In this experiment, on the end of the first cycle of intervention (25 days), the end of the fourth cycle of intervention (58 days), and the start of the seventh cycle of intervention (91 days), the level of insulin resistance (IR) and homeostatic-β cell function (B) Perform Homeostasis model assessment (HOME), among them:

HOMA-B=(20*fasting insulin)/(fasting blood glucose−3.5)%.

HOMA-IR((Homeostasis model assessment insulin resistance, HOME-IR))=(fasting blood glucose×insulin)/22.5.

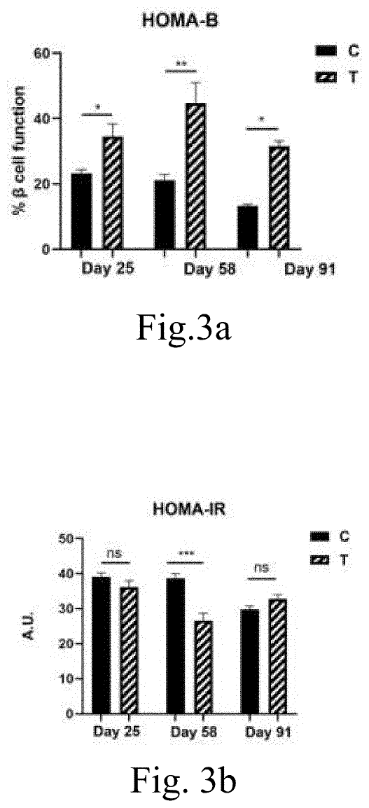

The results are shown in FIGS. 3a and 3b. The higher the HOMA-B value, the stronger the β cell function, and the lower the HOMA-IR value, the weaker the islet resistance. The results showed that CMNT intervention can significantly improve β cell function and insulin resistance in db/db mice.

3. Antioxidant Analysis

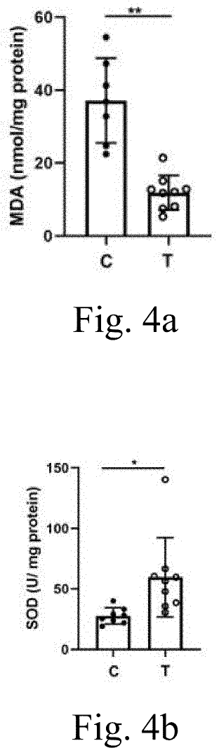

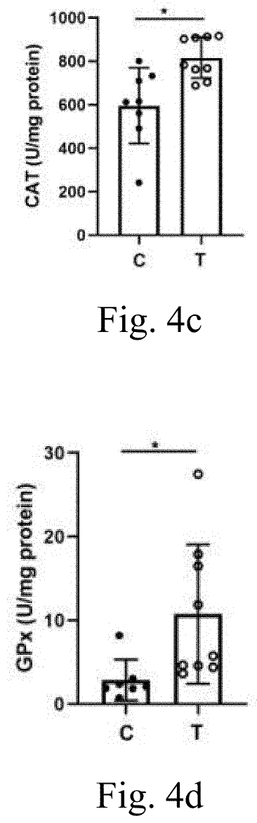

In this experiment, after the intervention of the three cycles, malondialdehyde (MDA), superoxide dismutase (SOD), glutathione peroxidase (GSH-Px) and catalase (CAT) and other oxidative stress biomarkers concentration levels, the results are shown in FIGS. 4a, 4b, 4c, and 4d, respectively.

The results showed that the SOD, CAT, and GSH-Px enzyme activities of the CMNT intervention treatment group were significantly higher than those of the control group. Malondialdehyde (MDA) is an important product of lipid peroxidation. It increases in the liver of mice and decreases after the intervention of CMNT, indicating that CMNT has a positive regulatory effect on oxidative stress in diabetic mice, indicating that CMNT can effectively improve Oxidative stress mediated by hyperglycemia. It also shows that CMNT has a good effect on improving the oxidative stress of the liver. The liver plays an important role in the regulation of glucose and lipid metabolism. Acetyl-CoA is the central hub of the connection of glucose and lipid metabolism. The activity of liver glucose and lipid metabolism enzymes is regulated by the post-translational modification of acetylation and deacetylation of lysine residues. In response to metabolism and energy needs.

2. Clinical Trials

63 participants were selected from primary care and outpatient services. According to the computer-generated sequence, the 63 participants were divided into treatment group (CMNT) and control group (conventional diet). The 90-day CMNT intervention included 6 cycles of 5 modified fasting days and 10 days followed by reintroduction of ordinary food. CMNT group: n=32; control group: n=31, included in the final analysis.

1. Analysis of Drug Withdrawal Rate

After discontinuing all antidiabetic drugs for at least 3 months, HbAlc (glycated hemoglobin) is stable below 7% (<53 mmol/mol), and the drug is deemed to be discontinued.

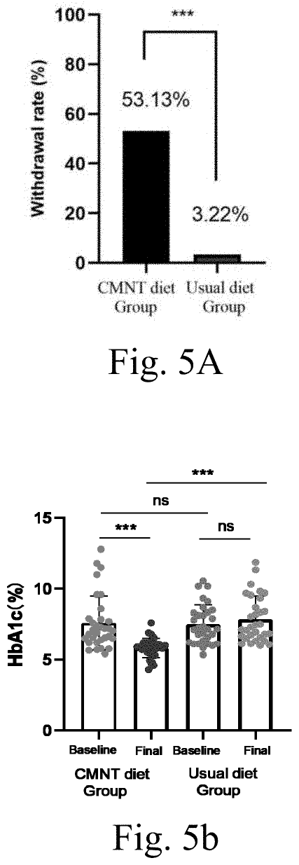

FIG. 5a is a comparison chart of drug withdrawal rates after intervention between the CMNT group and the conventional diet group. The results showed that the withdrawal rate of the CMNT group was 53.13%, and that of the control group was 3.22% (OR: 34.00, 95% Cl 4.12-280.41; p<0.0001).

2. HbAlc (Glycated Hemoglobin) Analysis

FIG. 5b is a comparison chart of the results of glycosylated hemoglobin before and after intervention in diabetic subjects in the CMNT group and the conventional diet group. The results showed that after the intervention of CMNT, the glycosylated hemoglobin of diabetic subjects decreased significantly and reached the normal level. There was no significant change in glycosylated hemoglobin in diabetic subjects with ordinary diet.

3. Analysis of Fasting Blood Glucose Level

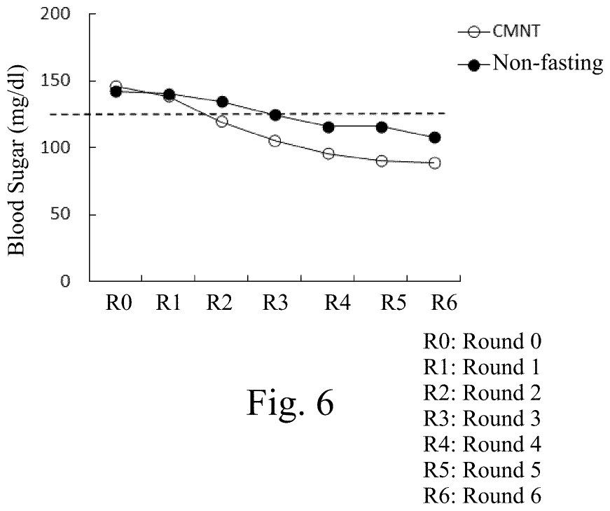

FIG. 6 is a comparison diagram of the effects of multiple rounds of CMNT simulated fasting and non-fasting phases in diabetic subjects. The results showed that the fasting blood glucose levels in both CMNT simulated fasting and non-fasting phases decreased significantly, indicating that CMNT intervention does not simply limit carbohydrate intake or energy restriction to reduce blood sugar.

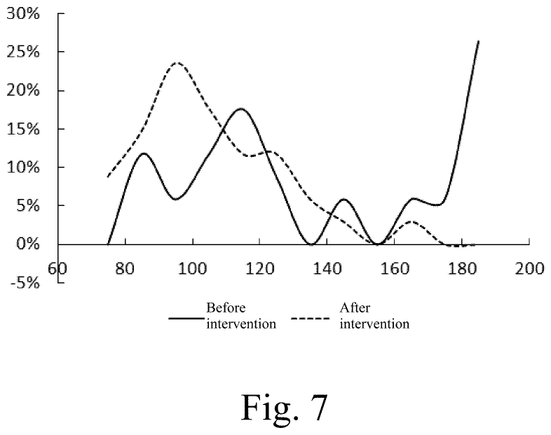

FIG. 7 is a comparison chart of the fasting blood glucose distribution of subjects before and after intervention. The abscissa represents the fasting blood glucose level (mg/dl) before and after the intervention, and the ordinate represents the percentage of the total number of diabetic subjects with each fasting blood glucose level.

TABLE 1
The fasting blood glucose levels of diabetic
subjects before and after CMNT intervention

| | Before intervention | After the intervention |
|---|---|---|
| | (mg/dl) | (mg/dl) |
| Minimum | 82.8 | 72 |
| 25% percentage | 110.7 | 97.2 |
| medium | 126 | 110.61 |
| 75% percentage | 175.05 | 124.65 |
| Maximum | 271.8 | 162 |

As shown in Table 1 above, CMNT intervention reduced the blood glucose levels of diabetic subjects who initially had high basal blood glucose (baseline>140 mg/dl). The results of FIG. 7 and Table 1 show that the pre-intervention blood glucose of diabetic subjects has a wide distribution, but whether the blood glucose is higher or relatively low, there is a significant improvement after CMNT intervention.

The above are the specific embodiments of the present invention, but cannot constitute any limitation to the present invention. Therefore, it should be particularly pointed out that any modification and improvement made on the basis of the present invention fall within the protection scope of the present invention.

1. A composition for treating diabetes based on traditional Chinese medicine nutritional therapy, wherein the composition is a low GI composition, and the composition comprises available carbohydrates, fat, protein, and dietary fiber and Chinese medicine extract components; wherein as a dosage of the composition for a day, an amount of dietary fiber presented in the composition is at a range of 10-40 g; a total energy of the composition is at a range of 400-1300 calories, wherein energy provided by the carbohydrates is 15-45% of a total energy of the composition; the energy provided by the fat is 40-80% of a total energy of the composition, and a mass fraction of unsaturated fatty acids takes 50-80 of a total mass of the fat, energy provided by an amount of protein takes 5-15% of the total energy of the composition; raw materials of the composition comprises 1-5 g of the Chinese medicine extract components;
wherein specifically, when applied, the composition is a solid food formed by processing multiple natural raw materials containing raw materials with auxiliary materials; wherein the solid food comprises breakfast, first dinner 1 and second dinner which are used in combination, wherein parts below is calculated by weight,
wherein the breakfast comprises 30-40 parts of fruit and vegetable porridge; the first dinner comprises 80-85 portions of nutritional rice and 30-35 parts of functional drink; the second dinner comprises 20-25 parts of biscuits and 30-35 parts of functional drink;
wherein the functional drink is a microcapsule powder corresponding to the fat, which is prepared by adding auxiliary materials to raw fats and fats derived from unsaturated fatty acids in the fat;
wherein the fruit and vegetable porridge is prepared by mixing fruit and vegetable powder prepared from the fruit and vegetable components in a carbohydrate source material with the functional beverage, and a mass ratio of the fruit and vegetable powder to the functional beverage is 1:1;
wherein the nutrient rice is prepared by mixing grain components and the traditional Chinese medicine extract components in the raw materials of carbohydrates, extruding and granulating; wherein a mass ratio of the grain components to the traditional Chinese medicine extract components is (30-80): (5-20);
wherein the biscuits are prepared by using fruit and vegetable components and grain components in carbohydrate source raw materials, as well as raw materials of the same medicine and food and adding auxiliary materials;
wherein in addition, the composition is applied to a diet of diabetic patients in an intermittent fasting diet; wherein the intermittent fasting diet specifically comprising: taking a first 2-8 days in each treatment cycle as a treatment period, during the treatment period, the composition is continuously used as the diet by the diabetic patients; taking a next 5-30 days as an intermittent period during which diet is free to eat.

2. The composition for treating the diabetes based on the nutritional therapy of traditional Chinese medicine according to claim 1, wherein among the raw materials of the composition, the available carbohydrates are mainly derived from the following natural raw materials comprising: mushrooms, zizania, Green onions, leeks, amaranth, konjac, celery, burdock, asparagus, black fungus, wax gourd, leaf add vegetable, loquat add vegetable, Chinese kale, vegetable moss, common cabbage, rutabaga, head cabbage, cauliflower, Brussels sprouts, Broccoli, cabbage, Chinese cabbage, leaf mustard, loquat mustard, stem mustard, shepherd's purse, long pepper, sweet pepper, toon, chrysanthemum, chicory, taro, coriander, winter squash, zucchini, cucumber, artichoke, Carrots, lentils, water chestnuts, edamame, day lily, Jerusalem artichoke, hericium, water spinach, lettuce, head lettuce, scalloped lettuce, gourd, shiitake mushroom, loofah, tomato, winter cold vegetables, bitter gourd, lotus root, jicama, Beans, bamboo shoots, peas, oyster mushrooms, radishes, edible rhubarb, Ci mushrooms, potatoes, eggplants, grass silkworms, spinach, white fungus, snake gourd, mushrooms, broad beans, cowpeas, straw mushrooms, rice whites, tomatoes, cabbage, potatoes, Carob, Pumpkin, Garlic, Cauliflower, Onion, Japonica Rice, Indica Rice, Glutinous Rice, Purple Rice, Barley, Wheat, Highland Barley, Buckwheat, Naked Oats, Oats, Corn, Millet, Millet, Millet, Millet, Sorghum, Soybean, Mung Bean, pea, broad bean, green bean, cowpea, and black bean.

3. The composition for treating diabetes based on the nutritional therapy of traditional Chinese medicine according to claim 1, wherein among the raw materials of the composition, the unsaturated fatty acids in the fat are mainly derived from the following raw materials: grape seed oil, Pumpkin seed oil, thorn grape seed oil, coconut oil, olive oil, wheat oil, sunflower oil, safflower seed oil, rapeseed oil, corn oil, peanut oil, hemp oil, camellia oil, tea seed oil, rice oil, One or more of walnut oil, pepper oil, lavender oil, linseed oil, perilla oil, and canola oil.

4. The composition for treating diabetes based on the nutritional therapy of traditional Chinese medicine according to claim 1, wherein among the raw materials of the composition, the source of the raw materials of medicine and food includes the following natural raw materials: cloves, star anise, knives Beans, cumin, milk thistle, yam, hawthorn, portulaca, black snake, ebony, papaya, hemp seed, Daidaihua, polygonatum, licorice, angelica, ginkgo, white lentil, white lentil flower, longan meat, Cassia Seed, Lily, Nutmeg, Cinnamon, Emblic, Bergamot, Almond, Seabuckthorn, Oyster, Gorgon, Pepper, Red Bean, Ejiao, Gallus gallus, Malt, kelp, Date, Luo Han Guo, Yu Li Ren, Honeysuckle, Green Fruit, Houttuynia, Ginger, Hovenia dulcis, Chinese wolfberry, Gardenia, Amomum villosum, Fatty sea, Poria, Citron, Citronella, Peach kernel, Mulberry leaf, Mulberry, Orange red, Platycodon grandiflorum, Alpinia, lotus leaf, Raisin, lotus seed, Galangal, light bamboo leaves, light tempeh, chrysanthemum, chicory, yellow mustard seeds, polygonatum, perilla, perilla seeds, kudzu root, black sesame, black pepper, Sophora japonica, locust flower, dandelion, honey, torreya, sour date kernel, fresh white Grass root, fresh reed root, agkistrodon, orange peel, mint, coix seed, scallion white, raspberry, ageratum, ginseng, mountain silver flower, coriander, rose, pine pollen, Chinese pine, pink kudzu, cloth residue leaf, prunella vulgaris One or more of, angelica, saffron, saffron, grass fruit, turmeric, long piper; or one or more of extracts corresponding to the natural raw materials.

5. The composition for treating diabetes based on the nutritional therapy of traditional Chinese medicine according to claim 1, wherein among the raw materials of the composition, the source of the Chinese medicine extract component comprises: Ganoderma lucidum polysaccharide, cordyceps extract, Luo Han Guo extract, Scutellaria baicalensis extract, Panax notoginseng extract, Perilla seed extract, Ginseng extract, Sophora flavescens extract, Burdock seed extract, Ginger extract, Tangerine peel extract, Lycium barbarum extract, Codonopsis extract, Astragalus extract, Eucommia ulmoides extract, honeysuckle extract, grape seed extract, Citrus aurantium extract, white willow bark extract, motherwort extract, Polygonatum extract, Atractylodes rhizome extract, Salvia miltiorrhiza extract, Shandou root extract, Sophora japonica extract, Licorice extract, Coptis extract, Polygonum multiflorum extract, Pulsatilla extract, Rhubarb extract, Poria extract, Aloe extract, Dandelion extract, Pueraria lobata extract, Hawthorn extract, Houttuynia cordata extract, Polygonatum odoratum extract, Green leaf extract, Radix isatidis extract, lotus leaf extract, Bupleurum extract, Forsythia extract, Momordica charantia extract, Acanthopanax senticosus extract, Olive extract, Gynostemma extract, Moringa extract, Peony One or more of bark extract, milk thistle extract, and violet extract.

6. The composition for treating diabetes based on the nutritional therapy of traditional Chinese medicine according to claim 1, wherein the functional drink is a pumpkin kernel prepared from raw pumpkin kernel oil derived from unsaturated fatty acids with auxiliary materials Oil microcapsule powder;
wherein the fruit and vegetable porridge is prepared by mixing the fruit and vegetable powder prepared by using the fruit and vegetable components in the carbohydrate source raw materials, dehydrated carrot powder, dehydrated cucumber powder, and dehydrated spinach powder, and the functional beverage, and the mass ratio of the fruit and vegetable powder to the functional beverage is 1:1;
wherein the nutrient rice is prepared by mixing, extruding and granulating oatmeal powder and ginseng extract, which are the grain component of the carbohydrate source material, and the ginseng extract component of the Chinese medicine extract; the mass ratio of the oat powder and the ginseng extract component of the Chinese medicine extract is (30-80): (5-20);
wherein the biscuit is prepared by adding at least one of the fruit and vegetable ingredient dehydrated carrot powder, dehydrated cucumber powder, and dehydrated spinach powder in carbohydrate source raw materials, oat powder with grain components, and lily powder, which is a raw material homologous to medicinal and food sources.

7. A method for preparing a diet or medicine for treating diabetes comprising a step of introducing the composition for treating diabetes based on the nutritional therapy of traditional Chinese medicine according to claim 1.
